(19) United States
(12) Patent Application Publication
(10) Pub. No.: US 2011/0093182 A1
(43) Pub. Date: Apr. 21, 2011

(54) ESTIMATING ENGINE PARAMETERS BASED ON DYNAMIC PRESSURE READINGS

(75) Inventors: Olaf Weber, Cupertino, CA (US); Wolfgang Wenzel, Stuttgart (DE)

(73) Assignee: BorgWarner BERU Systems GmbH, Ludwigsburg (DE)

(21) Appl. No.: 12/991,327

(22) PCT Filed: Apr. 28, 2009
(86) PCT No.: PCT/US09/41916

§ 371 Date: Nov. 5, 2010

Related U.S. Application Data
(60) Provisional application No. 61/051,383, filed on May 8, 2008.

(51) Int. Cl. F02D 28/00; G01M 15/04; G01M 15/10

(52) U.S. Cl. 701/102; 73/114.74; 73/114.37; 73/114.69; 73/114.25

(57) ABSTRACT

A method and system for estimating engine parameters in a combustion engine gas exchange system based on dynamic pressure readings taken by one or more pressure sensors. According to an exemplary embodiment, the method and system may use an artificial neural network (ANN) to process the dynamic pressure readings and any additional engine conditions that may have been provided.

This application claims the benefit of U.S. Provisional Application No. 61/051383 filed May 8, 2008.

### TECHNICAL FIELD

The field to which the disclosure generally relates includes pressure sensors used in combustion engine gas exchange systems.

### BACKGROUND

Internal combustion engines can use myriad sensors, such as pressure sensors, temperature sensors, airflow sensors, etc., to sense various engine conditions. Output signals, which are representative of the sensed engine conditions, can be provided from the sensors to an engine controller or other electronic module for monitoring, adjusting, manipulating, or otherwise controlling different engine operations.

### SUMMARY OF EXEMPLARY EMBODIMENTS OF THE INVENTION

One exemplary embodiment may include a method for estimating an engine parameter, comprising: (a) sensing pressure in a combustion engine gas exchange system; (b) providing dynamic pressure readings to an electronic controller, and (c) using the dynamic pressure readings to estimate at least one engine parameter.

Another exemplary embodiment may include a system for estimating an engine parameter, comprising: a pressure sensor being located in a first section of a combustion engine gas exchange system and having an electronic output; a mechanical device being located in the first section of the combustion engine gas exchange system so that it is in acoustic communication with the pressure sensor; and an electronic controller having an electronic input coupled to the electronic output of the pressure sensor, wherein the electronic controller estimates the position of the mechanical device from the dynamic pressure readings received from the pressure sensor.

### BRIEF DESCRIPTION OF THE DRAWINGS

Exemplary embodiments of the present invention will become more fully understood from the detailed description and the accompanying drawings, wherein:

FIG. 1 is a block diagram of a combustion engine gas exchange system such as the type that can be used in a vehicle, according to one exemplary embodiment;

FIG. 2 is a flowchart illustrating a method for estimating an engine parameter based on dynamic pressure readings, according to one exemplary embodiment; and

FIG. 3 is a flowchart further illustrating one of the steps of the method shown in FIG. 2, according to one exemplary embodiment.

### DETAILED DESCRIPTION OF EXEMPLARY EMBODIMENTS

The following description of the embodiment(s) is merely exemplary (illustrative) in nature and is in no way intended to limit the invention, its application, or uses.

### Combustion Engine Gas Exchange System

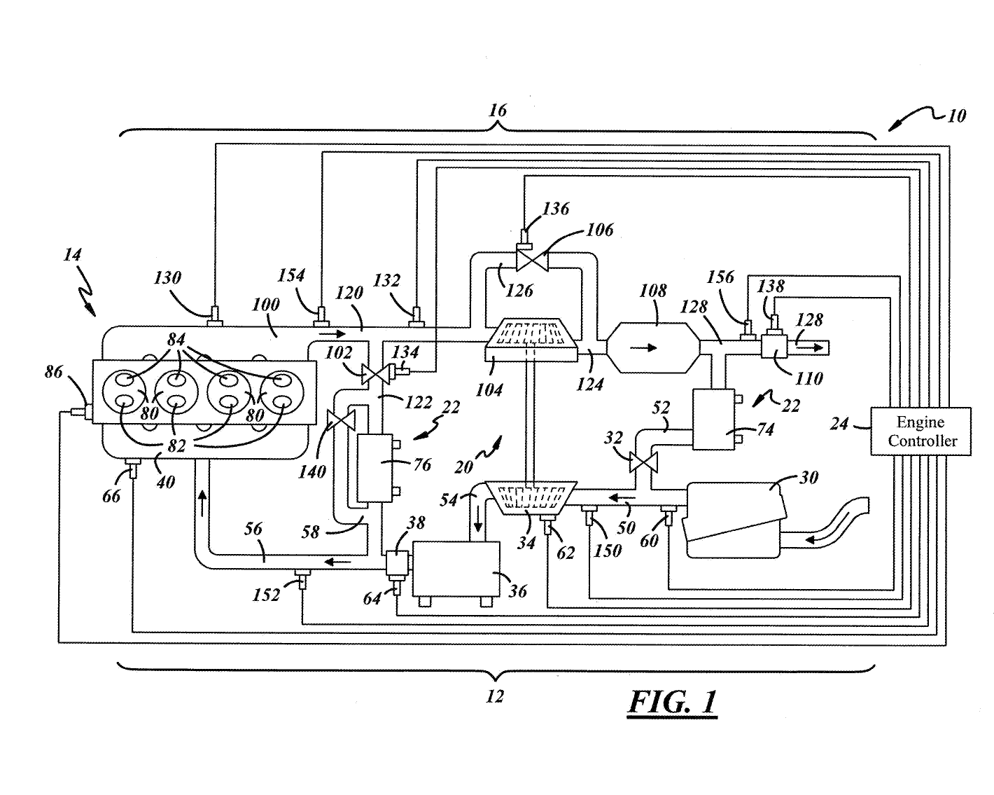

Referring to FIG. 1, there is shown a block diagram of an exemplary combustion engine gas exchange system 10, such as the type that can be used in a vehicle. In general, combustion engine gas exchange system 10 includes an intake system 12 that provides air to the engine, an engine 14 to develop mechanical power from the combustion of an air/fuel mixture, and an exhaust system 16 to remove combustion gases from the engine. Combustion engine gas exchange system 10 may also include a variety of additional devices, components, systems, etc. known to those skilled in the art, including the following: a turbocharger system 20 for compressing air and increasing engine output, an engine gas recirculation (EGR) system 22 for recirculating some of the exhaust gases in order to reduce emissions, an engine controller 24 for electronically controlling various aspects of engine operation, and a fuel system (not shown) for providing fuel to the engine.

As will be subsequently explained in more detail, pressure sensors may be mounted throughout combustion engine gas exchange system 10 so that they provide dynamic pressure readings that may be used to estimate or predict various engine parameters. In the following discussion of intake system 12, engine 14, and exhaust system 16, numerous examples of pressure sensor arrangements are provided. These are only some of the pressure sensor arrangements that are possible, however, as numerous other pressure sensor embodiments could be used as well. Moreover, for purposes of simplicity, only exemplary electronic connections between sensors and engine controller 24 are shown; i.e., only some of the engine controller inputs are shown, not engine controller outputs.

Intake system 12 may include, in addition to other known parts, an air filter 30, a low-pressure EGR valve 32 which is part of EGR system 22, a compressor 34 which is part of turbocharger system 20, an intercooler 36, an intake throttle valve 38, an intake manifold 40, passageways 50-58, and sensors 60-66. Many of the above-mentioned components are known and understood in the art, thus, a complete and exhaustive explanation of their functionality is not provided here.

Air filter 30 filters or cleans the incoming air by removing particulates and other debris so that they do not enter the cylinders and damage the engine. According to the exemplary embodiment shown here, air filter 30 is connected to a passageway 50 on its output side.

Low-pressure EGR valve 32 controls or regulates the introduction of low pressure EGR gases with fresh air in the intake system, and may be implemented as one of a number of different valve types and designs known in the art. In this exemplary embodiment, low-pressure EGR valve 32 is mounted in passageway 52 downstream of a cooler unit 74, which is used to cool exhaust gases before they are reintroduced into the intake system and is part of EGR system 22. Of course, components such as an EGR mixing unit, T-shaped coupling, etc. could also be used to join together passageways 50 and 52.

Compressor 34, which is part of turbocharger system 20, compresses the air or air/exhaust gas mixture in intake system 12 and provides engine 14 with a pressurized gas in order to increase the performance of the engine. As demonstrated in FIG. 1, compressor 34 shares a common axle or shaft with a turbine unit of turbocharger system 20 and operates according to principals generally known in the art. In this exemplary embodiment, compressor 34 is connected between passageway 50 on an upstream side and passageway 54 on a downstream side, however, other compressor arrangements and/or locations could be used instead.

Intercooler 36, also known as a charge air cooler, cools air in intake system 12 in order to improve the volumetric efficiency of the system, as is understood by skilled artisans. By decreasing the temperature of the air in intake system 12, intercooler 36 provides engine 14 with a denser charge which allows more air to be combusted per cycle; this can increase the output of the engine. According to the exemplary embodiment shown here, intercooler 36 is mounted in intake system 12 so that it is connected between passageways 54 and 56.

Intake throttle valve 38 affects the speed of the engine by controlling the air flow into intake manifold 40 and, consequently, engine 14. Intake throttle valve 38 is operably coupled to a gas pedal or accelerator in the vehicle and may manipulate airflow on the intake side of engine 14 according to the driver-dictated position of the gas pedal. In this exemplary embodiment, intake throttle valve 38 is a butterfly valve and is mounted in passageway 56 just upstream of where passageways 56 and 58 merge together. On diesel engines, the intake throttle may be used to reduce pressure in the intake path to force more exhaust gas to the intake side, it is partly closed in situations, when the pressure difference between intake and exhaust path is not high enough to drive the required EGR rate. This is, of course, only an exemplary arrangement for the intake throttle valve, as it could be located elsewhere in passageway 56 or in some other passageway or conduit. Additional passageway 58 is in communication with a cooler unit 76 and other components of the EGR system 22, and meets up with passageway 56 via a T-shaped coupling, mixer unit, or some other connection piece. It should be pointed out that in some exemplary diesel engines, the intake throttle valve can be used to create a vacuum for a low pressure EGR system.

Intake manifold 40 distributes air from intake system 12 to the various cylinders of engine 14, and is securely mounted to a cylinder head of the engine. Preferably, intake manifold 40 is designed to evenly distribute air to the different cylinders and, depending on the particular embodiment, can serve as a mount for a carburetor (if carbureted), fuel injectors (if fuel injected), as well as other components like pressure sensors. If indirect charge air cooling is applied to the engine, an water-to-air charge air cooler can be integrated in the intake manifold.

As previously mentioned, one or more sensors may be located throughout intake system 12 and may measure a wide range of engine conditions, including: airflow, temperature, pressure, the position of a device, etc. Sensors 60-66 are simply examples of possible sensors that could be used, as other sensors, sensor locations, sensor arrangements, etc. could be employed instead. In some embodiments, sensors 60-66 take single, discrete measurements of engine conditions and provide corresponding output to engine controller 24; e.g., a sensor takes a single airflow reading and sends this single reading to the engine controller. In other embodiments, sensors 60-66 dynamically measure or record an engine condition over time, and then provide that historical data to the engine controller; e.g., a temperature sensor could periodically sample the temperature in an intake system and then provide that time-based output to an engine controller, instead of providing a single temperature reading.

Airflow sensor 60 may measure the amount of air flowing through a segment of intake system 12 and can express this output in terms of volume per units of time (e.g., in L/s or ft³/min). In the exemplary embodiment shown here, airflow sensor 60 is mounted in passageway 50 just upstream from the junction where that passageway joins with passageway 52, and provides an intake airflow signal to engine controller 24. In this arrangement, the intake airflow signal is representative of the amount of outside, ambient air flowing into the system; i.e., it does not include gas flow from the EGR system 22. It should be appreciated that airflow sensor 60 may be mounted in one or more alternative locations within intake system 12 and can utilize an individual electronic output, a vehicle communications bus, a wireless network, or some other suitable electronic connection to send output data to engine controller 24.

Turbocharger speed sensor 62 can measure the rotational speed of compressor 34, and provide this output in terms of rotations per unit of time (e.g., rotations per minute (RPM), rotations per second, etc.). The resultant turbocharger speed signal may be sent to engine controller 24 or some other device, and can be helpful, for example, in optimally controlling operation of turbocharger system 20. Turbocharger speed sensor 62 may be used in addition to or in lieu of other speed sensors located throughout turbocharger system 20.

Throttle valve sensor 64 is coupled to intake throttle valve 38, and may be used to determine the operational position of the throttle valve and send a throttle valve position signal to engine controller 24. In the exemplary embodiment where throttle valve 38 is a butterfly valve, throttle valve sensor 64 may be an inductive sensor or other type of rotational position sensor that measures the rotational position of the throttle valve. Again, this is only one suitable type of throttle valve sensor, as other types of sensors could certainly be used.

Intake temperature sensor 66 may be one of a variety of different temperature sensor types, and is designed to provide an intake temperature signal to engine controller 24. According to the exemplary embodiment shown in FIG. 1, intake temperature sensor 66 is mounted to intake manifold 40 and senses the temperature of the air entering the intake manifold; this is only one possible arrangement. Other temperature sensors could be used in addition to or in lieu of the manifold-mounted temperature sensor 66, and they could be distributed throughout intake system 12. In some embodiments, it could be desirable to sense the temperature of the air on both sides of a device, such as intercooler 36. This could provide engine controller 24 or some other device with information regarding the amount of heat that intercooler 36 is removing from the incoming air. In other embodiments, it could be desirable to mount a temperature sensor at a position in passageway 50 that is upstream of the junction with passageway 52. This temperature sensor could then be used to determine ambient air temperature, before it is influenced or affected by EGR gases, pressurization, and other factors. Again, the preceding embodiments are only some of the possibilities.

Turning now to engine 14, the engine may be any type of internal combustion engine, including gasoline and diesel engines, as well as those that utilize other types of suitable liquid and/or gaseous fuels. Engine 14 includes a number of cylinders 80 for receiving reciprocating pistons (not shown), where each cylinder may include one or more intake valves 82 and one or more exhaust valves 84. A cylinder head is mounted to an engine block so as to define a separate combustion chamber for each cylinder, as is widely known and appreciated by those skilled in the art. Engine 14 may also include one or more sensors, including: an engine speed sensor, an engine temperature sensor, intake camshaft position sensors, exhaust camshaft position sensors, and other sensors known in the art. For purposes of simplicity, all four of these exemplary sensors have been combined into a single representative sensor 86, however, individual sensors could of course be used.

The exemplary engine shown in FIG. 1 is an inline four-cylinder engine. Other types of engines, including those having the same or differing number of cylinders, can also be used. Both the intake and exhaust valves 82, 84 may be operably coupled to a camshaft (not shown) so that they open and close in a timed precession with the intake and exhaust cycles of the engine. A variety of camming arrangements could be used, including those using overhead cams (single, dual, etc.), those using push rods, rocker arms, and valve stems, as well as any other camming mechanism known in the art. Each of the intake and exhaust valves 82, 84 may have a tapered circumference that is sized and shaped to nest within a chamfered or otherwise complementarily formed valve port in the cylinder head. This type of nesting arrangement enables the valves to properly close and seat during certain cycles of the engine, such as the compression stroke.

The engine speed sensor is coupled to engine 14 and can provide engine controller 24 with an engine speed signal that is indicative of the rotational speed and/or position of the engine. A variety of known engine speed sensors could be utilized, including ones that monitor the output of the engine crankshaft. The engine speed signal could be expressed in terms of rotations per unit of time (e.g., rotations per minute (RPM), rotations per second, etc.) and the engine position could be expressed relative to a top-dead-center (TDC) piston position (e.g. 10° before TDC, etc.) These are only some of the possibilities.

The engine temperature sensor senses the temperature of the engine and, more specifically, the temperature of engine coolant flowing through water jackets in the engine block, cylinder head, etc. The sensed temperature may be communicated to engine controller 24 in the form of an engine temperature signal or the like.

The intake and exhaust camshaft position sensors can measure the position of the intake and exhaust valves, respectively, and convey the position information to engine controller 24 in the form of intake and exhaust valve positions signals. It should be appreciated that there are a variety of sensors that could be used to determine the positions of the various intake and exhaust valves 80, 82. In an alternative embodiment, the engine position signal described above could be used to determine the various valve positions; the valves are coupled to a camshaft, and the camshaft is coupled to the crankshaft, which is being measured to determine the engine position.

The various sensors described above are exemplary sensors that could be used with engine 14. Of course, other sensors could be used in addition to or in lieu of the exemplary sensors, including oil pressure sensors, intake airflow sensors, pressure sensors, etc.

Exhaust system 14 may include, in addition to other known parts, an exhaust manifold 100, a high-pressure EGR valve 102 which is part of EGR system 22, a turbine 104 which is part of turbocharger system 20, a wastegate valve 106, a catalytic converter 108, an exhaust throttle valve 110, passageways 120-128, and sensors 130-136. As with the intake system, a number of the preceding exhaust system parts are known and understood in the art. Therefore, a complete and exhaustive explanation of their functionality is not provided here.

Exhaust manifold 100 routes exhaust or combustion gases from cylinders 80 so that they can be treated and discharged by the exhaust system 16. In this particular embodiment, exhaust manifold 100 is mounted to the exhaust side of the cylinder head and connects with passageway 120 in a many-to-one arrangement; i.e., multiple branches coming from cylinders 80 converge into a single branch connected to passageway 120. This specific exemplary engine has a single intake and exhaust manifold, however, other manifold arrangements can be used, including those having multiple intake and exhaust manifolds, or manifolds which are integrated into the cylinder head etc.

High-pressure EGR valve 102 is in communication with exhaust manifold 100 and controls the recirculation of some exhaust gases back to intake manifold 40. According to the exemplary embodiment shown here, high-pressure EGR valve 102 is mounted in passageway 122, which is connected between passageway 120 and a cooler unit 76, and may regulate the amount and timing of exhaust gas recirculation. In some instances, it may be beneficial for the recirculated exhaust gas to pass through cooler unit 76 before mixing with the incoming air in the intake system. In other instances, the hot exhaust gases may be directed around cooler unit 76 by a bypass valve 140, which is also part of the EGR system, so that hotter exhaust gases are introduced into the intake manifold 40.

Turbine 104 is part of turbocharger system 20 and uses exhaust gases to drive compressor 34, as already explained. In this exemplary embodiment, turbine 104 has an inlet that receives exhaust gas from passageway 120 and utilizes this gas to drive a rotatable wheel or turbine that rotates a common shaft extending between turbine 104 and compressor 34. Compressor 34 compresses air in the intake system 12 and provides the engine with pressurized air, which can improve engine performance by increasing the volumetric efficiency of the system, as discussed above. Turbine 104 includes an outlet connected to passageway 124 for conveying the exhaust gas further along the exhaust system 16. A variety of different turbocharger designs known in the art could be utilized, including variable geometry turbocharger (VGT) systems, single-turbo systems, twin-turbo systems, etc.

Wastegate valve 106 is designed to divert exhaust gas away from turbine 104 when the pressure in the turbocharger system 22 becomes too great. By diverting the exhaust gas around turbine 104—i.e., selectively bypassing the turbine—the turbine, and hence the compressor, lose rotational speed which reduces the pressure at intake manifold 40. In this way, the wastegate valve can be used to control or manipulate the turbocharger output and stabilize boost pressure in turbocharger system 22. The exemplary embodiment in FIG. 1 shows wastegate valve 106 mounted in a passageway 126 which bypasses the turbine and connects between passageways 120 and 124. Different types of wastegate valves may be used, including internal and external wastegate valves to name but a few.

Catalytic converter 108 reduces the toxicity of exhaust gas from engine 14 and, according to this exemplary embodiment, includes an inlet connected to passageway 124 and an outlet connected to passageway 128. As is appreciated by those skilled in the art, catalytic converter 108 uses a chemical reaction to convert toxic by-products of the combustion cycle into less toxic substances. A variety of catalytic converter types may be used including, but certainly not limited to, three-way converters, two-way converters, and diesel oxidation catalyst (DOC) converters and diesel particulate filters for diesel engines.

Exhaust throttle valve 110 can be used to regulate or otherwise manipulate the flow of exhaust gases from exhaust system 16. This, in turn, can affect engine conditions such as backpressure in the exhaust system. According to this particular embodiment, exhaust throttle valve 110 is mounted in passageway 128 and can increase the backpressure in order to drive EGR gases through EGR system 22. Some examples of additional downstream exhaust system components that could be used include nitrogen oxide (NOx) absorbers, soot filters, mufflers, tailpipes, etc.

One or more sensors 130-136 may be mounted in various locations throughout exhaust system 16 in order to measure different engine conditions. For example, one or more exhaust temperature sensors 130 may be used to measure exhaust gas temperature, oxygen (O₂) sensors 132 may be used to determine the oxygen content in the exhaust gas, and valve position sensors 134, 136, 138 could be coupled to valves, throttles, and other variable-position devices to determine their operational state or position. Where applicable, the discussion above regarding intake system sensors 60-68 generally applies to exhaust system sensors 130-138 as well. It should be appreciated that sensors 130-138 are only provided for exemplary purposes, as sensors that are of a different type, location, and/or quantity could also be used. Multiple sensors of the same type could also be used; e.g., three different temperature sensors used to measure temperature in three different locations of the exhaust system 16.

In addition to the sensors shown and discussed herein, any other suitable sensor and its sensed engine condition could be utilized in the presently disclosed system. For example, combustion engine gas exchange system 10 could also include accelerator pedal sensors, vehicle speed sensors, powertrain speed sensors, filter sensors, vibration sensors, knock sensors, turbocharger noise sensors, and/or the like. Moreover, other engine conditions and/or parameters can be used by the presently disclosed methods, including turbocharger efficiency, component fouling or balancing problems, filter loading, Diesel Particulate Filter (DPF) regeneration, EGR rate, LP-HP-EGR-fraction, cylinder charge mal-distribution based on air intake parameters not from high pressure values in the combustion chamber, and/or the like. In other words, any sensor could be used to sense any suitable engine condition including electrical, mechanical, and chemical conditions. As used herein, sensors can include both hardware and/or software components used to sense or otherwise measure engine conditions.

It should again be pointed out that combustion engine gas exchange system 10 is only an exemplary system and that other systems with other combinations and arrangements of components, devices, systems, etc. could also be used. For instance, non-turbocharged systems could also be utilized.

### Pressure Sensors

Combustion engine gas exchange system 10 may also include one or more pressure sensors 150-158 that are in communication with intake, exhaust, or other engine gases. Unlike pressure sensors that simply provide discrete and static gas pressure output readings, pressure sensors 150-158 are designed to measure a dynamic pressure behavior within a section of the combustion engine gas exchange system 10. Put differently, pressure sensors 150-158 may monitor pressure waves over a period of time and provide the corresponding dynamic pressure output to engine controller 24 or some other electronic controller in the vehicle via one or more electronic outputs.

According to the exemplary embodiment schematically shown in FIG. 1, pressure sensors 150-158 may be positioned throughout combustion engine gas exchange system 10, including locations in the intake system 12, engine 14, and exhaust system 16. For those pressure sensors installed in intake system 12, it may be desirable to: measure dynamic pressure waves having frequencies of less than or equal to approximately 3 kHz (this may be useful for speed monitoring for small turbochargers), measure dynamic pressure waves having amplitudes of less than or equal to approximately 200 dB, and be generally resistant to humidity in an intake air flow, to name but a few characteristics. Pressure sensors mounted in exhaust system 16 are exposed to different environmental conditions—namely, an air/fuel environment that is generally hotter and more corrosive than the mostly air environment of the intake system—and thus can have different sensor characteristics. For example, in addition to the 3 kHz and 200 dB operating parameters mentioned above, it may be desirable for exhaust system pressure sensors to be more heat and corrosion resistant so that they are not undesirably affected by hot exhaust gases, soot buildup, etc.

According to the embodiment shown in FIG. 1, pressure sensor 150 is mounted in passageway 50 between air filter 30 and turbocharger compressor 34. It is preferable, although not necessary, that pressure sensors 150-158 be mounted in such a way so as to obstruct the airflow as little as possible. In one embodiment, this could be accomplished by mounting the pressure sensors so that they are somewhat flush with the internal walls or surfaces of the passageways or other components to which they are mounted. Pressure sensor 150 is in acoustic communication with air filter 30, low-pressure EGR valve 32, and turbocharger compressor 34, and can measure dynamic pressure waves that are indicative of one or more engine parameters. For instance, the dynamic pressure behavior within passageway 50 may be influenced by the operating position of low-pressure EGR valve 32, or the speed of compressor 34, or the flowrate of air through air filter 30, to cite a few possibilities. The dynamic pressure behavior within passageway 50, as sensed by pressure sensor 150, can be used to predict or estimate one or more of these engine parameters, as will be subsequently explained in more detail.

Pressure sensor 152 is shown mounted in passageway 56 and is in acoustic communication with intake throttle valve 38, cooler unit 76, and intake manifold 40. Because pressure sensor 152 is in acoustic communication with each of these devices, certain parameters can be discerned from the dynamic pressure behavior in passageway 56. Stated differently, the dynamic pressure behavior in passageway 56 can have a relationship with the devices that are in acoustic communication with that passageway. For example, the operational positions of mechanical devices like intake throttle valve 38 and intake valves 82 can influence the dynamic pressure behavior sensed by pressure sensor 152. It should be noted that if pressure sensor 152 is mounted too close to intake valves 82, there could be undesirable noise, vibrations, etc. from the engine that could affect the integrity of the dynamic pressure readings. It is possible to mount pressure sensor 152 in intake manifold 100 or elsewhere, instead of in passageway 56.

Pressure sensor 154 is mounted in passageway 120 and is in acoustic communication with several mechanical devices including exhaust valves 84, high-pressure EGR valve 102, turbocharger turbine 104, and wastegate valve 106. Pressure sensor 154 is preferably mounted in the passageway so that it can measure a dynamic pressure behavior that provides information not only on the position and operation of exhaust valves 84, but also the operational state of high-pressure EGR valve 102, turbine 104, and wastegate valve 106. In this way, pressure sensor 154 can gather information on multiple devices simultaneously (in this case, the exhaust, EGR and wastegate valves, as well as the turbocharger turbine). If pressure sensor 154 is mounted in the exhaust manifold 100, instead of in passageway 120, it may be mounted in a manner so as to reduce noise and other undesirable signal components.

In an exemplary embodiment, pressure sensors 152 and 154 could be mounted so that they take dynamic pressure readings that are related to the positions of intake and exhaust valves 82 and 84, respectively. Such an embodiment could be used to replace valve position sensors (this could result in a cost savings), or it could be used in conjunction with valve position sensors in order to provide the system with redundancy. Redundant readings can sometimes be helpful in variable valve train systems, for example, where one or more aspects of valve operation is varied or otherwise controlled.

Pressure sensor 156 is mounted in passageway 128 and is in acoustic communication with catalytic converter 108, cooler unit 74, and exhaust throttle valve 110. Again, the particular sensor arrangement, location, etc. could vary from the exemplary embodiment shown in FIG. 1, so long as the pressure sensor is in acoustic communication with the device or devices from which it wishes to gather information.

It should be appreciated that pressure sensors 150-158 may be separate and independent devices or they may be integrated into other devices, sensors, systems, etc. Although the pressure sensors can be used in accordance with the methods described herein, they can also be used to take single, discrete pressure measurements for the enhancement of engine system control and diagnostics. For example, pressure sensors can be used to control cylinder-to-cylinder timing and fueling to compensate for individual cylinder differences. As will be subsequently described in more detail, the following methods can take advantage of the pressure sensors in order to estimate engine parameters that are normally measured using other dedicated sensors.

### Method

According to an exemplary embodiment, method 200 uses one or more dynamic pressure readings from pressure sensors 150-158 to estimate or predict at least one engine parameter, other than pressure, within combustion engine gas exchange system 10. Depending on the particular application, the estimated engine parameter may be used to: replace one or more sensors that would otherwise directly measure the estimated engine parameter (this could result in a cost savings), corroborate the readings of one or more sensors (this could be used for purposes of redundancy), or detect device or sensor malfunctions (this could result in improved reliability), to cite but a few possibilities.

Beginning with step 202, pressure sensor 152 senses pressure in combustion engine gas exchange system 10 and, more specifically, in passageway 56 which is in acoustic communication with intake throttle valve 38, bypass valve 140, and one or more intake valves 82. Pressure sensor 152 may take one or more dynamic pressure readings that are representative of the dynamic pressure behavior in passageway 56 over a certain period of time. It should be appreciated that although the following example is directed to pressure sensor 152, any pressure sensor in system 10 could be used; this includes any of the pressure sensors 150-158, as well as pressure sensors that are mounted in other locations in system 10 and are not specifically mentioned here. The dynamic pressure readings can be analog or digital (although they are usually analog and later converted to digital), and generally provide a history of the pressure in that section of system 10 over a certain period of time. In one example, a dynamic pressure reading includes a digital compilation of discrete pressure readings that have been sampled at a certain frequency for a certain period. For instance, a single dynamic pressure reading may extend for 1 second and include 1,000 individual and discrete pressure measurements sampled at a rate of 1 kHz.

Next, additional engine conditions, such as engine speed, are determined by one or more sensors, components, systems, etc. in combustion engine gas exchange system 10, step 204. The dynamic pressure readings taken from a section of system 10, such as passageway 56, can be influenced and affected by these additional engine conditions. Thus, it is sometimes helpful to augment the dynamic pressure readings with additional engine conditions. Engine speed is only one example, however, of additional engine conditions that could be determined in step 204 and used by method 200. Other additional engine conditions like airflow, temperature, oxygen (O₂) content, valve positions, etc. could also be used. It should be appreciated that this is an optional step. Sometimes dynamic pressure readings from pressure sensors 150-158 will provide all of the information that is required to estimate an engine parameter, and additional information is not necessary.

The dynamic pressure readings and additional engine conditions can be sent from the originating sensors to engine controller 24 as soon as they are sensed, or they can be processed, stored, etc. before being provided to the engine controller. There are a number of techniques known in the art for conditioning or processing sensor readings and providing them to an electronic controller for processing; any of these techniques could be used here. For example, the data could be filtered with a high-pass filter, low-pass filter, or other noise reducing technique at this point.

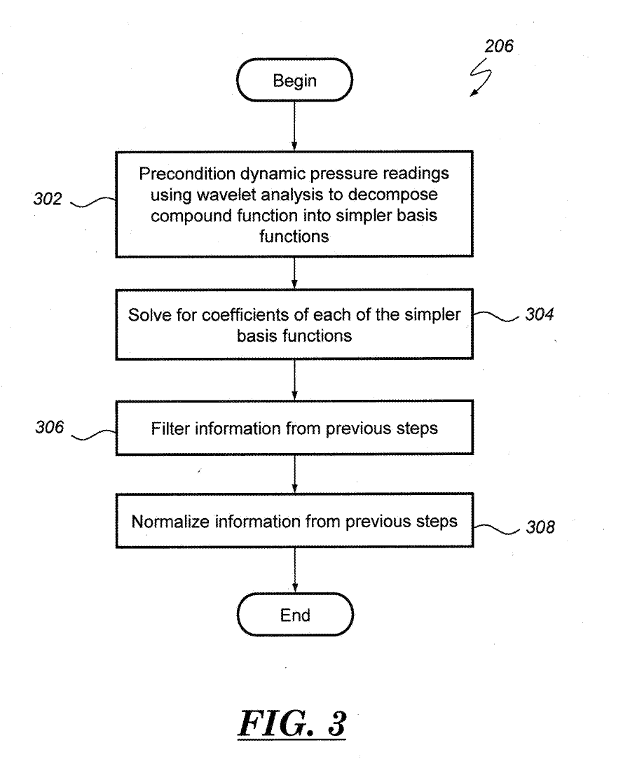

In step 206, the dynamic pressure readings and/or the additional engine conditions from the previous steps may be preprocessed by one or more signal processing techniques. Generally, step 206 preprocesses the information previously obtained so that the data can be compressed, condensed, filtered, or otherwise refined without losing too much information. One exemplary embodiment of step 206 is shown in more detail in FIG. 3, and includes using a wavelet analysis to decompose the dynamic pressure readings (compound function) into one or more simpler basis functions, step 302. Two examples of suitable wavelet analyses include a Haar-type analysis and a Daub-type analysis, although others could be used as well.

Each of the simpler basis functions is based on a particular frequency and includes a coefficient that is representative of both the amplitude and phase. In step 304, the method solves for the coefficient of each of the simpler basis functions. There are a variety of ways for solving for these coefficients. In an exemplary embodiment, the wavelet analysis is performed by commercially available software, such as Matlab which has a signal analysis tool package for performing this type of operation. The solution for the different coefficients may be used to help estimate one or more engine parameters, as will be explained in more detail.

In an alternative embodiment, steps 302 and 304 are replaced with a different harmonic analysis technique, such as a Fourier analysis. In a similar fashion, a Fourier analysis can be used to break up or decompose the original compound function—in this case the dynamic pressure readings—into one or more simpler basis functions that are sinusoidal in nature. Solving for a coefficient for each of the simpler basis functions yields information regarding the amplitude and phase; information that can be used to help estimate one or more engine parameters. In an exemplary embodiment, a fast Fourier transform (FFT) is used. It should be appreciated that other techniques, like principal component analysis, feature selection method, and other harmonic analysis techniques, are known in the art and could be employed here.

Next, step 306 filters the information from the previous steps to remove any outliers or other unacceptable components. According to one exemplary embodiment, step 306 uses a band-pass filter to filter out or remove any of the simpler basis functions that are based on frequencies falling outside of a predetermined frequency range or bandwidth. The cutoff frequencies could be specifically selected for the particular pressure sensor 150-158 that is providing the dynamic pressure readings or for the particular device or engine parameter that is being estimated. Of course, other types of filters and techniques could also be used, including low pass, high pass, Butterworth, Chebyshev, and elliptic filters, to name but a few. It is also possible to select or control the band-pass characteristics (e.g., the cut-off frequencies, bandwidth, etc.) based on the additional engine conditions gathered in step 204. For instance, the cutoff frequencies could be selected based on the sensed engine speed. If additional engine conditions, like engine speed or temperature, were gathered in step 202, then this information could be filtered as well.

In step 308, the information from the previous steps may be normalized to take into account wide ranging values. For example, the coefficients corresponding to the simpler basis functions and the additional engine conditions optionally gathered in step 202 could differ from each other by one or more orders of magnitude. This can sometimes complicate subsequent data processing, thus, step 308 may involve a normalization process where all of the values are translated into values between two predetermined limits, for example, 0 and 1. Generally, the content in the information is not lost, rather it is converted into a form that can be subsequently processed in an easier and more efficient manner. This step is optional, as it is possible to use the information from the previous steps without any type of normalization process.

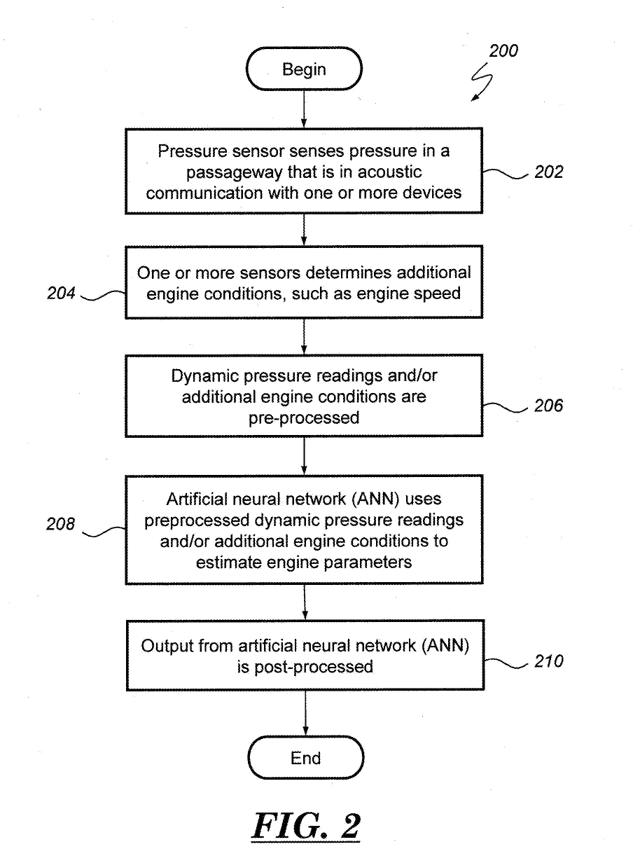

Once preprocessing is complete, control can return to step 208 in FIG. 2. It should be appreciated that the exemplary steps shown in FIG. 3 are representative of only some of the possible preprocessing steps. Skilled artisans will understand that other steps, in addition to or in lieu of steps 302-308, could alternatively be used. In one exemplary embodiment, the preprocessing steps outlined in FIG. 3 only apply to the dynamic pressure readings sensed in step 202, and do not apply to any additional engine conditions determined in step 204. Any additional engine conditions may optionally be preprocessed with their own set of preprocessing steps, for example.

Referring back to FIG. 2, the preconditioned dynamic pressure readings and/or additional engine conditions are used to estimate one or more engine parameters, step 208. The dynamic pressure readings are representative of the dynamic pressure behavior in the section of system 10 that is being sensed or monitored. As previously explained, the dynamic pressure behavior in passageway 56, for example, may have a relationship with the operational position of intake throttle valve 38, bypass valve 40, one or more intake valves 82, and any other devices in acoustic communication with sensor 152. If throttle valve 38 is half open, the dynamic pressure behavior in passageway 56 can be different than if the same valve is fully open. If a valve is not seating properly, this could affect the dynamic pressure behavior as well. Thus, step 208 uses one of a variety of techniques, including formulaic, empirical, statistical, and other known techniques to estimate engine parameters. In an exemplary embodiment, step 208 uses a technique that involves the use of an artificial neural network (ANN).

By way of example, an artificial neural network (ANN) is an information processing network or paradigm that can include inputs, outputs, and one or more integrated circuit (IC) chips mounted on a printed circuit board (PCB) or the like. Each of the IC chips can include a number of highly interconnected neurons (sometimes called nodes or processing elements) mounted thereon, wherein each neuron generally includes a memory unit and an evaluator unit. The memory unit stores information gleaned from a learning or teaching phase; an example of such information is an input pattern. The evaluator unit utilizes the information stored in the corresponding memory unit to process some portion of the input data; for instance, in the embodiment above, a single evaluator unit could be used to process all or part of one of the simpler basis functions derived from the dynamic pressure readings. Generally speaking, the neurons are designed to work in unison or parallel with each other in order to solve specific and oftentimes very complex problems. Because of their ability to derive meaning from complicated and imprecise data, their adaptive learning attributes, and their ability to utilize numerous processing elements solving tasks in parallel, to name but a few of their characteristics, ANNs may be employed in a variety of applications. Some suitable applications involve pattern recognition and/or data classification.

In an exemplary embodiment, step 208 involves training and using an artificial neural network (ANN) to derive one or more engine parameters from the preprocessed dynamic pressure readings and/or the engine conditions previously determined. In a training phrase, each of the neurons may be trained or conditioned to issue a certain output for particular input patterns. There are numerous methods and techniques that can be used to train or learn an ANN, including supervised and unsupervised learning approaches. A typical training or learning phase may also involve the assignment of connection weights which, in adaptive neural networks, are modified through experience; this can provide the ANN with certain artificial intelligence capabilities. In the exemplary embodiment used here, the training phase can utilize information obtained from operating the combustion engine gas exchange system 10 in a controlled environment such as an instrumented vehicle on a test track, on a dynamometer, in an emissions laboratory, or in some other manner known in the art.

Once the ANN is properly trained, it may be used to process input and deliver certain output. In the exemplary embodiment, the trained ANN receives the preprocessed dynamic pressure readings and/or additional engine conditions, analyzes the data, and attempts to estimate certain predetermined engine parameters based on pattern recognition and the like. Although it is possible to develop the ANN so that it outputs multiple engine parameter estimates (e.g., with dynamic pressure readings from pressure sensor 152 as input, the ANN determines the operational positions of both throttle valve 38 and bypass valve 140), the corresponding artificial neural network could be quite large and use many processing resources. Therefore, in order to make some applications more efficient, a separate ANN could be developed for each engine parameter being estimated.

It should be appreciated that the description above is a general description of an exemplary ANN and that many different ANNs of varying type, as well as other artificial intelligence systems like support vector machines, could be used. For more information on training, using, and other aspects of artificial neural networks, please see: Neural Networks—A Systematic Introduction, by Rual Rojas, Foreward by Jerome Feldman, Springer-Verlag, Berlin, New-York, 1996 (502 p., 350 illustrations); An Introduction to Neural Networks, by Ben Krose and Patrick van der Smagt, Eighth Edition November 1996, © 1996 University of Amsterdam; Schölkopf, Smola: Learning with Kernels, MIT Press, 2001; Rosenblatt, F. (1958), “The Perceptron, a Probabilistic Model for Information Storage and Organisation in the Brain”, in Psychological Review, 62/386; and Vapnik and Chervonenkis, Theory of Pattern Recognition, 1979.

Once the artificial neural network delivers an output, the information may need to be post-processed in order to transform it into a more useable form, step 210. For example, if the preprocessed information was normalized in step 308, then the post-processing step could de-normalize the output of the ANN to return it to its original form. In some embodiments, it may be useful to output a valve position reading in the form of a control signal. Put differently, instead of outputting the absolute or relative position of a valve (e.g., throttle valve is 25% open), step 210 may provide an output that is representative of the duty cycle that corresponds to the estimated position. This could enable the system to more quickly and efficiently transition into motor control algorithms and the like.

In one embodiment, method 200 senses pressure in a section of combustion engine gas exchange system 10 that is in acoustic communication with at least one of the following mechanical devices: an exhaust gas recirculation (EGR) valve 32, 102, 140, a turbocharger compressor 34, a turbocharger turbine 104, a throttle valve 38, 110, a wastegate valve 106, an intake valve 82, or an exhaust valve 84. The sensed pressure is then provided to engine controller 24 or some other electronic controller so that the position of the corresponding mechanical device can be determined according to the method previously described.

In another embodiment, method 200 is used to estimate at least one of the following engine parameters: intake air temperature, exhaust air temperature, intake airflow, or exhaust air flow. Unlike the previously mentioned engine parameters which pertained to the location of mechanical devices, these engine parameters relate to different intangible conditions in the combustion engine gas exchange system 10. Of course, other engine parameters could be estimated with the method and system described above, as the engine parameters specifically mentioned are only exemplary in nature.

The above description of embodiments of the invention is merely exemplary in nature and, thus, variations thereof are not to be regarded as a departure from the spirit and scope of the invention. Various combinations of the above-described methods, procedures, modes, features, systems, etc. could be used together. Moreover, the methods and procedures described above could employ a sequence or combination of steps that differs from the exemplary embodiments described. Put differently, it is not necessary for the methods and procedures to follow the precise order of the exemplary embodiments provided above; they could be in a different order or have a different combination of steps.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

What is claimed is:

1. A method for estimating an engine parameter, comprising:
(a) sensing pressure in a combustion engine gas exchange system;
(b) providing dynamic pressure readings to an electronic controller, wherein the dynamic pressure readings are representative of the sensed pressure taken over a period of time; and
(c) using the dynamic pressure readings to estimate at least one engine parameter.

2. The method of claim 1, wherein step (a) further comprises sensing pressure in a section of the combustion engine gas exchange system that is in acoustic communication with at least one mechanical device selected from the list consisting of: an exhaust gas recirculation (EGR) valve, a turbocharger compressor, a turbocharger turbine, a throttle valve, a wastegate valve, an intake valve, or an exhaust valve; and
step (c) further comprises using the dynamic pressure readings to estimate the position of the at least one mechanical device.

3. The method of claim 1, wherein step (c) further comprises using the dynamic pressure readings to estimate at least one engine parameter by: (i) preconditioning the dynamic pressure readings, and (ii) processing the preconditioned dynamic pressure readings with an artificial neural network (ANN).

4. The method of claim 3, wherein step (i) further comprises preconditioning the dynamic pressure readings by using a wavelet analysis to decompose a compound function representative of the dynamic pressure readings into a plurality of simpler basis functions, wherein an amplitude and phase is determined for each of the simpler basis functions.

5. The method of claim 4, wherein the wavelet analysis is a Haar wavelet analysis or a Daub wavelet analysis.

6. The method of claim 3, wherein step (i) further comprises preconditioning the dynamic pressure readings by using a fast Fourier transform (FFT) to decompose a compound function representative of the dynamic pressure readings into a plurality of simpler basis functions in the frequency domain, wherein an amplitude and phase is determined for each of the simpler basis functions.

7. The method of claim 3, wherein step (i) further comprises preconditioning the dynamic pressure readings by normalizing values between two predetermined limits before processing the preconditioned dynamic pressure readings in step (ii).

8. The method of claim 3, wherein step (ii) further comprises processing the preconditioned dynamic pressure readings with an artificial neural network (ANN) having one or more inputs that receive the dynamic pressure readings, a plurality of neurons, and one or more outputs that provide the at least one estimated engine parameter.

9. The method of claim 1, wherein step (c) further comprises using the dynamic pressure readings to estimate at least one engine parameter selected from the list consisting of: intake air temperature, exhaust air temperature, intake airflow, or exhaust airflow.

10. The method of claim 1, wherein step (b) further comprises providing one or more additional engine conditions to the electronic controller; and
step (c) further comprises using the dynamic pressure readings and the additional engine conditions to estimate the at least one engine parameter.

11. The method of claim 10, wherein the one or more additional engine conditions includes engine speed.

12. The method of claim 1, wherein step (a) further comprises sensing pressure in a section of the combustion engine gas exchange system that is in acoustic communication with at least two different mechanical devices; and
step (c) further comprises using the dynamic pressure readings to estimate the position of the at least two different mechanical devices.

13. A system for estimating an engine parameter, comprising:
a pressure sensor being located in a first section of a combustion engine gas exchange system and having an electronic output, wherein the pressure sensor provides dynamic pressure readings on the electronic output that are representative of the dynamic pressure behavior in the first section of the combustion engine gas exchange system;
a mechanical device being located in the first section of the combustion engine gas exchange system so that it is in acoustic communication with the pressure sensor; and
an electronic controller having an electronic input coupled to the electronic output of the pressure sensor, wherein the electronic controller estimates the position of the mechanical device from the dynamic pressure readings received from the pressure sensor.

14. The system of claim 13, wherein the mechanical device is selected from the list consisting of: an exhaust gas recirculation (EGR) valve, a turbocharger compressor, a turbocharger turbine, a throttle valve, a wastegate valve, an intake valve, or an exhaust valve.

15. The system of claim 13, wherein the electronic controller uses an artificial neural network (ANN) having one or more inputs that receive the dynamic pressure readings, a plurality of neurons, and one or more outputs that provide the estimated position of the mechanical device.

16. The system of claim 13, wherein the system further comprises one or more additional sensors for sensing and providing additional engine conditions to the electronic controller; and
wherein the electronic controller estimates the position of the mechanical device from the dynamic pressure readings and the additional engine conditions.

17. The system of claim 16, wherein the one or more additional engine sensors includes an engine speed sensor that provides an engine speed signal.

18. The system of claim 13, wherein the pressure sensor is in acoustic communication with at least two different mechanical devices; and
the electronic controller estimates the positions of the at least two different mechanical devices from the dynamic pressure readings.

19. The system of claim 13, wherein the pressure sensor: is mounted in an intake system of the combustion engine gas exchange system, measures dynamic pressure waves having frequencies of less than or equal to 3 kHz, measures dynamic pressure waves having amplitudes of less than or equal to 200 dB, and is resistant to humidity in an intake air flow.

20. The system of claim 13, wherein the pressure sensor: is mounted in an exhaust system of the combustion engine gas exchange system, measures dynamic pressure waves having frequencies of less than or equal to 3 kHz, measures dynamic pressure waves having amplitudes of less than or equal to 200 dB, and is resistant to heat and corrosion in an exhaust air flow.
